(19) United States
(12) Patent Application Publication
(10) Pub. No.: US 2025/0256803 A1
(43) Pub. Date: Aug. 14, 2025

(54) FASTENING ARRANGEMENT FOR A BICYCLE, A BICYCLE WITH THE SAME AND PRE-ASSEMBLED UNIT

(71) Applicant: MAHLE International GmbH, Stuttgart (DE)

(72) Inventors: Alberto Angulo Martinez, Burgos (ES); Irene Carnicero Gomez, Valladolid (ES); Antonio Lebaniegos, Laredo (ES)

(21) Appl. No.: 19/048,842

(22) Filed: Feb. 7, 2025

(30) Foreign Application Priority Data
Feb. 8, 2024 (DE) 102024103557.9

(51) Int. Cl. B62M 6/40; B62K 19/30

(52) U.S. Cl. CPC B62M 6/40; B62K 19/30

(57) ABSTRACT

A fastening arrangement for fastening a drive unit to a bicycle frame may include a step screw, a nut, a first screw holder, and a second screw holder. The step screw may include a shaft and a head. The shaft may include a threaded section, a first unthreaded round section arranged on the threaded section, a second unthreaded round section arranged on the first unthreaded round section, and a circumferential shaft step arranged between the first unthreaded round section and the second unthreaded round section. The head may be arranged on the second unthreaded round section of the shaft. The first screw holder may include a first hollow cylindrical base body and a first longitudinal bore extending through the first base body. The second screw holder may include a second hollow cylindrical base body and a second longitudinal bore extending through the second base body.

### CROSS-REFERENCE TO RELATED APPLICATION

This application claims priority to German Patent Application No. DE 102024103557.9, filed on Feb. 8, 2024, the contents of which is hereby incorporated by reference in its entirety.

### TECHNICAL FIELD

The present invention relates to a fastening arrangement for a bicycle, in particular an e-bike or a pedelec. The invention relates in particular to a bicycle with the same, as well as, in particular, a pre-assembled unit.

### BACKGROUND

In bicycles of the aforementioned type, different fastening arrangements are used today to attach a drive motor of the bicycle to a bicycle frame, see for example document WO 2022/043182 A1, in which an exemplary fastening arrangement is described. The disadvantage of the known fastening devices is that they are cost-intensive, particularly due to the large number of components involved, and also difficult to assemble. Another challenge is to provide sufficient vibration damping through the fastening arrangements so that vibrations from the drive motor are not transmitted to the frame and vibrations from the frame, which occur when the frame is externally excited while the bicycle is in motion, are not transmitted to the drive.

### SUMMARY

The task of the invention is therefore to provide a fastening arrangement for a bicycle which is improved with respect to the above-mentioned disadvantages or at least another embodiment, by means of which a drive unit of the bicycle and a bicycle frame can be mounted relatively easily and, in addition, sufficient vibration damping and/or decoupling is made possible. Furthermore, a bicycle with such a fastening arrangement and a pre-assembled unit are to be provided.

In the present invention, this problem is solved by the subject matter of the independent claim(s). Advantageous embodiments are the subject matter of the dependent claim(s), the description, and the drawings.

The basic idea of the invention is to provide a fastening arrangement for a bicycle, in particular an e-bike or a pedelec, which has a reduced number of components compared to the known fastening arrangement and/or also enables sufficient vibration damping and/or decoupling.

The invention proposes a fastening arrangement for a bicycle, in particular an e-bike or a pedelec, comprising a step screw for fastening the drive unit to a bicycle frame of the bicycle, which has a shaft with a threaded section, with a first unthreaded round section arranged on the threaded section, with a second unthreaded round section arranged on the first round section, thread-free round section and with a shaft step, which is arranged between the first round section and the second round section and runs around a screw center axis of the step screw, as well as a head arranged on the second round section of the shaft. The threaded section is or has a free screw end facing away from the head of the step screw, as well as a nut. Furthermore, it is envisaged that the fastening arrangement has a first screw holder, which has a hollow-cylindrical base body penetrated by a longitudinal bore, and a second screw holder, which has a hollow-cylindrical base body penetrated by a longitudinal bore, wherein the base bodies of the two said screw holders are insertable or inserted into two opposing housing openings of a housing of a drive unit of the bicycle, which housing openings define a common opening center axis of a housing of a drive unit of the bicycle. The base body of the first screw holder, which is also referred to herein as the first base body, can be fixed or is fixed in a rotationally secure and axially secure manner on an inner circumference facing the opening center axis of a first housing opening of the said housing openings of the housing, and the base body of the second screw holder, which is also referred to herein as the second base body, can be fixed or is fixed in a rotationally secure and axially secure manner on an inner circumference, facing the axis of the opening, of a second housing opening of the housing of the said housing openings, in a rotationally and axially fixed manner or fixed. Furthermore, it is useful if the bicycle frame has two openings opposite each other that are aligned with the two openings of the drive unit casing when the bicycle is assembled. Furthermore, it is envisaged that the step screw can be pushed through the two frame openings, the two housing openings and the longitudinal holes of the base body of the screw holders, or is pushed through and is supported or can be supported with its head touching the bicycle frame. In addition, a spacer element, in particular a washer, made of metal or plastic or another (elastic) material can be arranged between the head of the step screw and the bicycle frame. Furthermore, the first base body can be supported or is supported on the first round section, the second base body can be supported or is supported on the second round section and the said nut can be screwed or is screwed onto the threaded section of the stepped screw and tightened or are tightened in such a way that the nut can be supported or is supported on the bicycle frame and the first base body can be clamped or is clamped between the shank step of the stepped screw and the bicycle frame. For the specialist, it is immediately and unambiguously clear that the threaded section of the stepped screw has a male thread that is designed to complement the female thread of the nut, so that the male and female threads are thread-compatible with each other.

This makes it relatively easy and inexpensive to mount the drive unit and the bicycle frame together. Furthermore, it is possible to disassemble the drive unit from the bicycle frame comparatively quickly and cheaply by removing the nut from the step screw and pulling the step screw out of the frame openings, the two housing openings and the longitudinal holes of the base body of the screw holders.

It may be expedient to provide that the second base body is supported on the second round section by means of a sliding seat, in particular a second sliding seat. In other words, the second base body is mounted directly on the stepped screw. This means that the step screw can be or is pushed through the longitudinal hole of the second base body when the drive unit is mounted on the bicycle frame and, in particular, can be or is aligned along the axis of the center of the opening relative to the second base body.

It may be the case that the second basic body absorbs exclusively or (at least) essentially exclusively radial forces. Furthermore, the second base body can be provided between the head of the step screw and the shaft step of the step screw.

Furthermore, it may be envisaged that, for example in the intended use of the bicycle, the first base body is supported in a sliding seat, in particular in a first sliding seat, on the first round section. In other words, the first base body is mounted directly on the stepped screw. As a result, when the drive unit is mounted on the bicycle frame, the step screw can be or is pushed through the longitudinal hole of the first base body and, in particular, can be or is aligned along the axis of the center of the opening relative to the first base body.

In this context, it may be envisaged that, when the bicycle is used as intended, the first and/or second base body absorbs both axial and radial forces.

Furthermore, another step, in particular a circumferential undercut, could be arranged between the first round section and the thread section.

It may also be envisaged that the threaded section has a thread diameter, the first rounded section has a first diameter and the second rounded section has a second diameter, with the second diameter of the second rounded section being larger than the first diameter of the first rounded section and/or the first diameter of the first rounded section being larger than or the same size as the thread diameter of the threaded section. This describes a functional design of the step screw that ensures quick and easy mounting of the drive unit on the bicycle frame. It is advantageous that the first round section has a smaller diameter than the second round section, so that the inner sleeve of the first base body has a smaller inner diameter than the inner sleeve of the second base body. In other words, the outer sleeve of the first base body is dimensioned larger than the outer sleeve of the second base body. Alternatively or additionally, the inner sleeve of the first base body can be dimensioned larger than the inner sleeve of the second base body. A larger inner sleeve in the first basic body has the advantage that the inner sleeve can absorb correspondingly larger axial and/or radial forces.

The shaft of the stepped screw can be designed as a solid shaft or as a hollow shaft, as appropriate. In particular, the full shaft is free or (at least) essentially free of cavities. The hollow shaft may be penetrated by a through-hole extending along the centerline of the stepped screw over the entire length of the shaft. In this case, the through-hole can also pass completely through the head of the stepped screw axially. In the sense of the invention, a full shaft does not have a through-hole extending along the center axis of the screw over the entire length of the shaft. The head of the fully shank set screw may have a tool-holding opening extending through the head partially or completely and along the screw centerline for the insertion of an operating tool.

Furthermore, it may be the case that the nut is designed as a cap nut or as a nut with a through-hole. In particular, the cap nut has an opening with an internal thread, wherein the opening does not pass through a head section of the cap nut. In the case of the nut with a through-hole, the through-hole completely penetrates the nut. In both the cap nut and the nut with a through opening, the internal thread can either extend completely or only partially along the opening or the through opening.

“Openings” in the sense of the invention are in particular recesses and in particular holes.

Furthermore, it may be provided that the nut is designed as a concentric nut or an eccentric nut. An inexpensive eccentric nut that can be provided in large numbers can prevent an unwanted opening movement of the eccentric nut caused by vibrations/shocks occurring during the intended use of the bicycle. The bicycle frame can have a housing holding section that is designed to complement the eccentric nut, in which the eccentric nut is received in the assembled state of the bicycle and on which the eccentric nut is supported against the opening movement.

It may also be provided that the nut or the eccentric nut is held in the bicycle frame, in particular in a housing holding section of the bicycle frame that is designed to match the nut or the eccentric nut, in such a way that the nut or the eccentric nut is at least partially or completely immersed in the housing holding section. This keeps the nut or eccentric nut from protruding above a surface of the bicycle frame, either at all or only in sections, which can prevent injuries or damage.

In particular, it may be provided that the first base body and the second base body each have an outer sleeve and an inner sleeve, wherein in each case the inner sleeve is fixed to the outer sleeve and the inner sleeve is received coaxially inside the outer sleeve. As a result, the base bodies have different layers, so to speak, by means of which the mechanical properties, in particular damping properties and/or rigidity properties, of the base bodies can be adapted, within certain limits, to the conditions that occur during the intended use of the bicycle.

It may be provided that the outer sleeve is made of a material with vibration-damping and/or vibration-decoupling properties or is made of such a material and is designed to dampen and/or decouple vibrations between the bicycle frame and the drive unit. A suitable material with vibration-damping and/or vibration-decoupling properties could be a rubber material, for example, or an elastomer or a silicone. The outer sleeve can also be made of a mixture of different rubber materials or a mixture of different rubber materials and a metal or a metal mesh or metal alloy(s) or similar other materials. By means of appropriately designed screw holders, the bicycle frame can be effectively decoupled from the drive unit, so that vibrations caused by the drive unit are practically not transmitted to the bicycle frame, and vice versa. This significantly increases the comfort experienced by the cyclist when handling the bike, especially while riding. The material with vibration-damping and/or vibration-decoupling properties can be selected so that vibrations of a certain frequency are dampened.

Furthermore, it may be provided that the outer sleeve has an anti-rotation device, by means of which a respective base body is fixed or can be fixed in a respective housing opening in a rotationally fixed manner. The anti-rotation device may be formed by a longitudinal projection or have one. The longitudinal projection can extend along the outside of the outer sleeve. In this case, it is useful if the longitudinal projection of the anti-rotation device can be or is arranged in at least one longitudinal groove of the drive unit casing, which is located in one of the said openings in the casing. Alternatively or additionally, a reverse solution is conceivable in which the longitudinal projection is arranged in one of the said openings in the housing and the outer sleeve has a longitudinal groove forming the anti-rotation device, which extends, for example, longitudinally on the outside of the outer sleeve along the outside of the outer sleeve.

In particular, it may be provided that the inner sleeve is made of a metallic or (hard) plastic material or is made from such a material. This allows a preferred rigidity of the base body to be generated by means of the inner sleeve, in particular in the direction of the longitudinal bore of the base body in question.

It is useful if the inner sleeve has one single or two opposing outer flanges. If there is only one outboard bearing, it is located either on the side of the inner sleeve facing the bicycle frame or on the side of the inner sleeve facing away from the bicycle frame. The outboard motor is conveniently located at one end of the inner sleeves. The outer sleeves are preferably arranged on opposite sides of the inner sleeves. Furthermore, it may be provided that the outer bands or the outer band extend radially over the inner sleeve and/or completely around the inner sleeve in a circumferential direction. By means of correspondingly designed inner sleeves, the first base body can be supported on the section of the bicycle frame facing the first base body and on the shaft step of the step screw, and optionally the second base body can be supported on the section of the bicycle frame facing the second base body. However, it is advantageous that a distance, in particular an air gap, is set between the second base body or the outboard of the inner sleeve of the second base body and the section of the bicycle frame facing the second base body during intended operation of the bicycle.

In a further embodiment of the invention, it may be provided that the second basic body, in particular its outer sleeve, has axially protruding knobs. It is functional that in the intended use of the bicycle, the second base body is supported on the bicycle frame by means of the axially protruding knobs, in particular on the section of the bicycle frame facing the second base body. This can prevent a gap, especially an air gap, between the second base body and the bicycle frame. In other words, the axially protruding knobs of the second base body provide an axial lock to the bicycle frame. It is advisable for the first base body not to have any axially protruding knobs.

Furthermore, it is conceivable that the first base body and the second base body, that is to say the first screw holder and the second screw holder, are connected or cannot be disconnected from the housing of the drive unit, so that the housing of the drive unit, the first base body and the second base body form a coherent, in particular single-piece, unit. This can be achieved in particular by the said base bodies being vulcanized onto the housing of the drive unit. For example, by providing the said base bodies each with an outer sleeve made of a rubber material and the housing of the drive unit made of a metal. In the case of a plastic housing for the drive unit, it would also be conceivable to bond the aforementioned base bodies to it in such a way that they cannot be detached. However, it may also be provided that the first base body and the second base body, i.e., the first screw holder and the second screw holder, are designed to be interchangeable. This means that the first screw holder and the second screw holder can be replaced during the service life of the bicycle and the vibration damping and/or vibration decoupling of the bicycle frame with respect to the drive unit, which is achieved by means of this component, can be renewed. In the case of interchangeably designed base bodies, it may also be provided that the first base body and the second base body, i.e., the first screw holder and the second screw holder, are pressed into a respective housing opening of the drive unit housing.

Furthermore, it may be provided that, when the bicycle is assembled, at least one base body is elastically compressed along the axis of the center of the opening and/or the axis of the center of the screw and is elastically expanded radially with respect to the axis of the center of the opening and/or the axis of the center of the screw. Preferably, the first base body or the first base body and the second base body can be elastically compressed along the axis of the center of the opening and/or the axis of the center of the screw and elastically expanded radially with respect to the axis of the center of the opening and/or the axis of the center of the screw. Furthermore, the outer sleeve of the first base body, which is preferably made of a material with vibration-damping and/or vibration-decoupling properties, in particular rubber or elastomer or silicone, and/or the outer sleeve of the second base body, which is preferably made of a material with vibration-damping and/or vibration-decoupling properties, in particular rubber or elastomer or silicone, can be elastically expanded along the axis of the center of the opening and/or the axis of the center of the screw and be elastically widened radially with respect to the axis of the center of the opening and/or the axis of the center of the screw. The radial expansion allows the base body or bodies to be clamped to the housing of the drive unit. The radial expansion is achieved by screwing the nut onto the stepped screw and tightening it, as explained above, so that the nut is supported on the bicycle frame and the first base body is clamped between the shaft step of the stepped screw and the section of the bicycle frame facing the drive unit housing. The clamping is designed to be releasable, since both the axial compression of the base body or bodies and the radial expansion of the base body or bodies are purely elastic in nature, i.e., completely reversible or (at least) essentially reversible. This has the advantage that the clamping can be completely released if necessary and the arrangement of the drive unit on the bicycle frame can be loosened without destroying it.

The invention further relates to a bicycle, in particular an e-bike or pedelec, which has at least one fastening arrangement designed in accordance with the preceding description, a drive unit for driving the bicycle and a bicycle frame designed to carry the drive unit and a rider. The base bodies of the two screw holders are intended to be inserted into two opposing housing openings of a drive unit housing, defining an opening center axis, in such a way that the base body of the first screw holder is fixed in a rotationally and axially secure manner on an inner circumference, facing the opening center axis, of a first housing opening of the said housing openings of the and furthermore the base body of the second screw holder is fixed in a rotationally and axially fixed manner on an inner circumference facing the opening center axis of a second housing opening of the housing of the said housing openings of the housing. Furthermore, it is envisaged that the bicycle frame has two opposing frame openings which, when the bicycle is assembled, are aligned with the two housing openings of the drive unit housing, with the stepped screw being inserted through the two frame openings, the two housing openings and the longitudinal holes of the base bodies of the screw holders and being supported with its head touching on the bicycle frame. Furthermore, the first base body is supported on the first round section and the second base body is supported on the second round section. The nut in question is screwed onto the threaded section of the step screw and tightened in such a way that the nut is supported on the bicycle frame and the first base body is clamped between the shaft step of the step screw and the bicycle frame. Furthermore, in the assembled state of the bicycle, at least one base body or, alternatively, the first base body and the second base body, in particular the outer sleeve of the first base body and/or the outer sleeve of the second base body, is elastically compressed along the axis of the center of the opening and elastically expanded radially with respect to the axis of the center of the opening. This indicates a preferred bicycle with at least one fastening arrangement.

The invention also proposes a pre-assembled unit that has a drive unit for a bicycle, in particular an e-bike or a pedelec, and at least one fastening arrangement as described above. The drive unit has at least one opening in the housing for fastening or securing the drive unit by means of at least one fastener, which can be realized in particular by a step screw. To form the pre-assembled unit, the base bodies of the screw holders of the at least one fastening arrangement are designed to be inserted or inserted in a removable manner into the at least one housing opening of the drive unit. This indicates a preferred pre-assembled unit for a bicycle.

Further important features and advantages of the invention are apparent from the dependent claims, from the drawings and from the associated description of the figures with reference to the drawings.

It is understood that the above-mentioned features and those yet to be explained below can be used not only in the combination indicated in each case, but also in other combinations or on their own, without deviating from the scope of the present invention.

Preferred embodiments of the invention are shown in the drawings and are explained in more detail in the following description, wherein identical reference signs refer to identical or similar or functionally identical components.

### BRIEF DESCRIPTION OF THE DRAWINGS

They show, schematically in each case

FIG. 1 shows a sectional view of a preferred embodiment of the fastening arrangement according to the invention in an assembled state,

FIG. 2 shows a sectional view of a further preferred embodiment of the fastening arrangement according to the invention in an assembled state,

FIG. 3 shows a perspective view of a preferred embodiment of a second screw holder of a fastening arrangement according to the invention.

### DETAILED DESCRIPTION

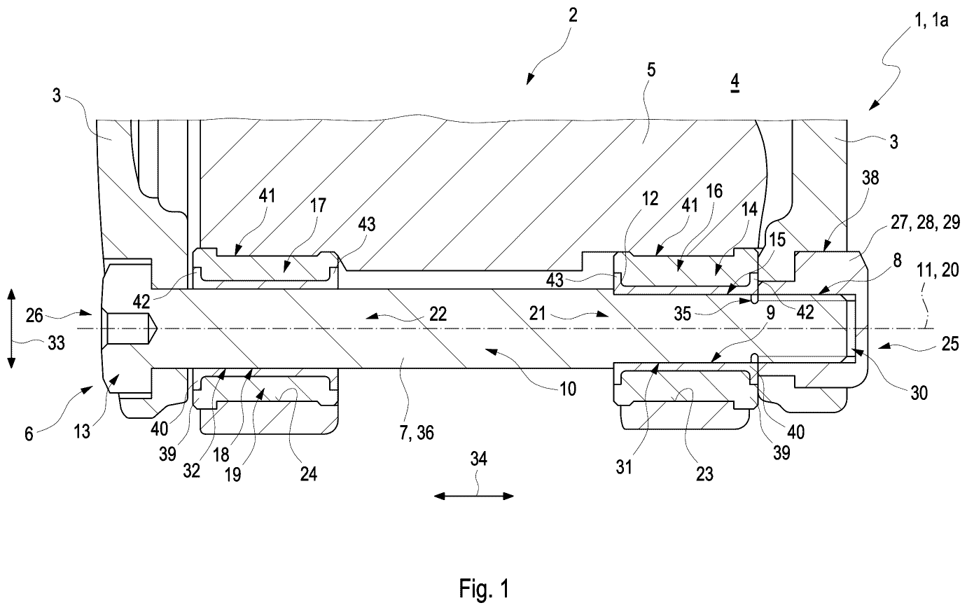

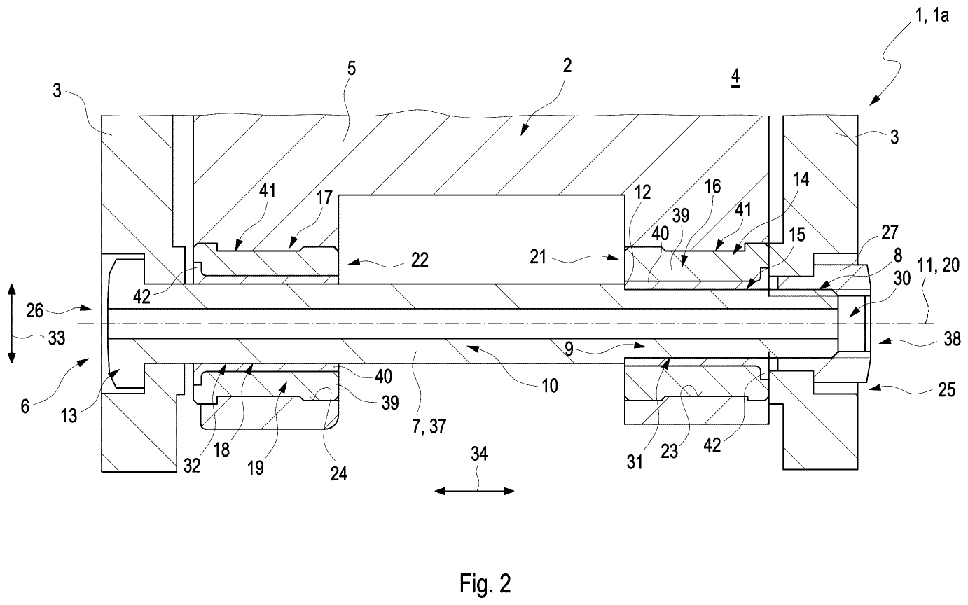

FIGS. 1 and 2 each show, in a preferred embodiment, a fastening arrangement designated by the reference number 1a for a bicycle designated as a whole by 1, which has a drive unit 2 for driving the bicycle 1 and a bicycle frame 3 for supporting the drive unit 2 and a rider, not illustrated, of the bicycle 1, wherein the drive unit 2 is a separate component with respect to the bicycle frame 3, so that there is a need for a cost-effective and simple assembly of the drive unit 2 to the bicycle frame 3. The drive unit 2 is designed purely exemplarily as an electric drive and has in particular a non-illustrated electric motor housed in a possibly multi-part housing 5 of the drive unit 2, in particular a light metal housing, which is designed to drive a wheel of the bicycle 1, which is also arranged on the bicycle frame 3, according to a requirement or the specifications of the rider.

The drive unit 2 can be easily mounted on the bicycle frame 3. For this purpose, the present fastening arrangement 1a has at least one one-piece step screw 6 extending along a screw center axis 11 for fastening the drive unit 2 to the bicycle frame 3. The step screw 6 has a shaft 7 which has a threaded section 8 with an external thread, a first unthreaded round section 9 arranged on the threaded section 8, and a second unthreaded round section 10 arranged on the first round section 9. A head 13 of the step screw 6 is arranged on the second round section 10. The threaded section 8 forms a free axial end of the step screw 6, opposite the head 13. By way of example, it is envisaged that the threaded section 8 has a thread diameter, the first round section 9 has a first diameter and the second round section 10 has a second diameter, with the second diameter of the second round section 10 being larger than the first diameter of the first round section 9 and the first diameter of the first round section 9 being larger than the thread diameter of the threaded section 8. As a result, the shaft 7 of the stepped screw 6 has a stepped character and, between the first round section 9 and the second round section 10, a shaft step 12 that runs all the way around the screw center axis 11 and defines an annular surface that is perpendicular to the screw center axis 11 and faces the free axial end of the stepped screw 6, on which a first base body 16, which will be explained below, can be supported. In addition, a circumferential undercut 35 can be provided between the first round section 9 and the thread section 8.

The head 13 of the stepped screw 6 is integrally arranged on the second round section 10 of the shaft 7. The diameter of the head 13 is larger than the diameter of the first round section 9, the diameter of the second round section 10, and the thread diameter of the threaded section 8.

Furthermore, according to the embodiment illustrated in FIG. 1, the shaft 7 of the stepped screw 6 is realized as a full shaft 36. In contrast to this, a lighter constructional variant is provided in the embodiment illustrated in FIG. 2, where the shaft 7 of the stepped screw 6 is realized as a hollow shaft 37 with an axial through-bore.

In accordance with the embodiments of the fastening arrangement 1a for the bicycle 1 illustrated in FIGS. 1 and 2, a first screw holder 14, which has a hollow-cylindrical first base body 16 penetrated by a longitudinal bore 15, and a second screw holder 17, which has a hollow-cylindrical second base body 19 penetrated by a longitudinal bore 18, is provided. In FIGS. 1 and 2, it can also be seen that the two base bodies 16, 19 of the two screw holders 14, 17 are inserted into two opposing housing openings 21, 22 of the housing 5 of the drive unit 2, which define an opening center axis 20, in such a way that the first base body 16 of the first screw holder 14 is fixed in a rotationally secure and axially secure manner on an inner circumference 23, facing the opening center axis 20, of a first housing opening 21 of the housing 5 of the said housing openings 21, 22 of the housing 5, and the second base body 19 of the second screw holder 17 is fixed on an inner circumference 24, facing the opening center axis 20, of a second housing opening 22 of the housing 5 of the said housing openings 21, 22 of the housing 5 is fixed in a rotationally and axially secure manner. In this case, the said rotationally fixed and axially fixed fastening is realized, for example, by a press-fitting of the two said base bodies 16, 19 when inserting them into the housing 5.

The bicycle frame 3 has two opposing frame openings 25, 26, which, in an assembled state 4 of the fastening arrangement la, illustrated in FIG. 1 and FIG. 2, are aligned with the two housing openings 21, 22 of the housing 5 of the drive unit 2, since the drive unit 2 with its housing openings 21, 22 are positioned in sections between two parallel housing legs of the housing 5, in which the said housing openings 21, 22 of the housing 5 are arranged in each case. In other words, the openings in the frame mark 25, 26 respective fastening points at which the drive unit 2 is or can be fastened accordingly.

Furthermore, it is envisaged that the stepped screw 6 is inserted through the two frame openings 25, 26, the two housing openings 21, 22 and the longitudinal holes 15, 18 of the two base bodies 16, 19 of the screw holders 14, 17, with its head 13 being supported at one end in contact with the bicycle frame 3 and at the other end the free axial end of the step screw 6 is arranged in one of the housing openings 21, 22 and/or projects above the housing 5. The center axes of the screws 11 and the center axis of the opening 20 are parallel and aligned with each other. Furthermore, it can be seen that the first base body 16 is supported on the first round section 9 in a first sliding seat 31 and the second base body 19 is supported on the second round section 10 in a second sliding seat 32, so that the first base body 16 and the second base body 19 and the stepped screw 6, at least as long as a nut 27 is not is tightened, are adjustable relative to one another independently of one another along the screw center axis 11 and/or the opening center axis 20. The said nut 27 is provided for the final fastening of the drive unit 2 to the bicycle frame 3, which is screwed onto the threaded section 8 of the stepped screw 6 and then tightened in such a way that the nut 27 rests against an outer side of the bicycle frame 3 pointing away from the drive unit 2 and the first base body 16 is clamped axially between the shaft step 12 of the stepped screw 6 and the bicycle frame 3. As a result, the first basic body 16 can no longer be adjusted along the screw center axis 11 and/or the opening center axis 20. The second base body 19 is not axially clamped, so that it retains a certain longitudinal adjustability in the direction of the screw center axis 11 and/or the opening center axis 20. This ensures in particular that the first base body 16 absorbs both axial forces 34 and radial forces 33, while the second base body 19 absorbs only radial forces 33, i.e., with negligible friction effects.

Furthermore, according to the embodiment illustrated in FIG. 1, it is envisaged that the said nut 27 is realized as an eccentric nut 29 or as an eccentric cap nut 28, so to speak a cap nut eccentric. The bicycle frame 3 has a housing holding section 38 which is designed to be complementary with respect to the eccentric nut 28, 29, in which, in the assembled state 4 of the fastening arrangement 1a, the eccentric nut 28, 29 enters and on which the eccentric nut 28, 29 is supported against any unintentional opening movement of the eccentric nut 28, 29 caused by vibrations occurring during occurring vibrations caused by the opening movement of the bicycle 1. The eccentric nut 28, 29 is configured in the present case so that it is partially immersed in the housing holding section 38, so that a head section of the eccentric nut 28, 29 projects above an outer side of the bicycle frame 3. The eccentric nut 28, 29 in question has an opening 30 which the eccentric nut 28, 29 only penetrates in sections, and thus not completely.

Furthermore, according to the embodiment illustrated in FIG. 2, said nut 27 is realized as a commercially available symmetrical nut 27 with a through-opening 30. The through-hole 30 completely penetrates the nut 27. Commercially available screw locking devices, which are not illustrated, can be used to secure the screw connection against unintentional loosening.

According to the embodiments of the fastening arrangement 1 illustrated in FIGS. 1 and 2, it is further provided that the first base body 16 and the second base body 19 each have an outer sleeve 39 and an inner sleeve 40, wherein the inner sleeve 40 is fixed to the outer sleeve 39 and the inner sleeve 40 is coaxially received inside the outer sleeve 39. The outer sleeves 39 are made of a material with vibration-damping and/or vibration-decoupling properties and are designed to decouple vibrations from the bicycle frame 3 with respect to the drive unit 2. This means that, when the bicycle 1 is used as intended, vibrations occurring at the drive unit 2 cannot be transmitted to the bicycle frame 3, and vice versa. Furthermore, the outer sleeves 39 can each have an anti-rotation device 41, by means of which a respective base body 16, 19 can be fixed or is fixed in a respective housing opening 21, 22 in a rotationally fixed manner. The said inner sleeves 40 are made of a metallic material or a (hard) plastic material. Furthermore, according to the embodiment illustrated in FIG. 1, it is envisaged that the inner sleeves 40 each have two opposing outer flanges 42, 43, whereas, in contrast, according to the embodiment illustrated in FIG. 2, it is envisaged that the inner sleeves 40 each have only a single outer flange 42, which is provided on a side facing the bicycle frame 3. It is equally conceivable that the embodiment in accordance with FIG. 2 also has two opposite outboard sections 42, 43. Furthermore, it is conceivable that the outboard 42, 43 in accordance with FIG. 2 are each provided on a side facing away from the bicycle frame 3.

It should also be mentioned that, in addition, it may be provided that, in the said assembled state 4 of the bicycle 1, the outer sleeve 39 of the first base body 16 and/or the outer sleeve 39 of the second base body 19 are elastically compressed along the axis 20 of the center of the opening and radially with respect to the axis 20 of the center of the opening.

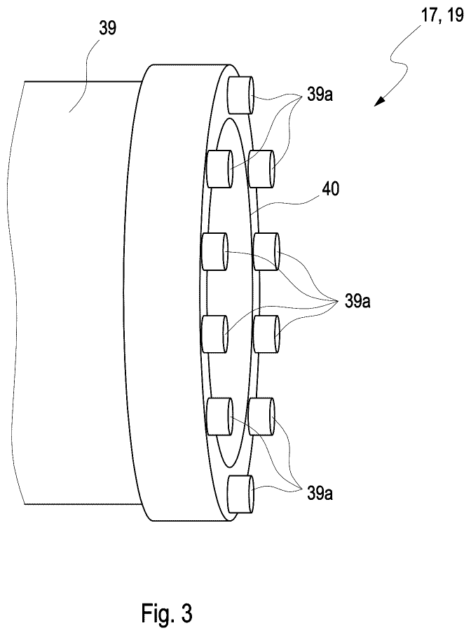

FIG. 3 shows the second screw holder 17 with the second base body 19 in a preferred embodiment, in which the second base body 19, in particular its outer sleeve 39, has a plurality of axially protruding, evenly distributed knobs 39a. In the intended use of the bicycle 1, the second base body 19 can be supported on the bicycle frame 3 by means of the axially protruding knobs 39a. The burls 39a, for example, are integrally designed with the outer sleeve 39 and can have a cylindrical, in particular circular cylindrical, burl body.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. A fastening arrangement for a bicycle for fastening a drive unit of the bicycle to a bicycle frame of the bicycle, comprising:
a step screw including a shaft and a head, the shaft including:
a threaded section;
a first unthreaded round section arranged on the threaded section;
a second unthreaded round section arranged on the first unthreaded round section; and
a circumferential shaft step arranged between the first unthreaded round section and the second unthreaded round section;
the head arranged on the second unthreaded round section of the shaft;
a nut;
a first screw holder including a first hollow cylindrical base body and a first longitudinal bore extending through the first base body; and
a second screw holder including a second hollow cylindrical base body and a second longitudinal bore extending through the second base body;
the first base body and the second base body insertable into two opposing housing openings of a housing of the drive unit such that i) the first base body is fixable in a rotationally and axially secure manner on an inner circumference, which faces an opening center axis defined by the two housing openings, of a first housing opening of the two housing openings and ii) the second base body is fixable in a rotationally and axially secure manner on an inner circumference, which faces the opening center axis, of a second housing opening of the two housing openings;
the step screw insertable through i) two opposing frame openings of the bicycle frame, which in an assembled state of the bicycle are aligned with the two housing openings of the drive unit, ii) the two housing openings, iii) the first longitudinal bore of the first screw holder, and iv) the second longitudinal bore of the second screw holder with the head of the step screw touching the bicycle frame;
wherein the first base body is supportable on the first unthreaded round section;
wherein the second base body is supportable on the second unthreaded round section; and
wherein the nut is screwable onto the threaded section of the step screw and is tightenable such that i) the nut is supported on the bicycle frame and ii) the first base body is clamped between the shaft step of the step screw and the bicycle frame.

2. The fastening arrangement according to claim 1, wherein the second base body is supported in a sliding seat on the second unthreaded round section.

3. The fastening arrangement according to claim 1, wherein the second base body absorbs exclusively radial forces.

4. The fastening arrangement according to claim 1, wherein the first base body is supported in a sliding seat on the first unthreaded round section.

5. The fastening arrangement according to claim 1, wherein the first base body and/or the second base body absorbs both axial forces and radial forces during use of the bicycle.

6. The fastening arrangement according to claim 1, wherein the threaded section has a thread diameter, the first unthreaded round section has a first diameter, and the second unthreaded round section has a second diameter, and wherein:
the second diameter is greater than the first diameter; and/or
the first diameter is greater than or equal to the thread diameter.

7. The fastening arrangement according to claim 1, wherein the shaft is a solid shaft.

8. The fastening arrangement according to claim 1, wherein the nut is a cap nut.

9. The fastening arrangement according to claim 1, wherein the nut is a concentric nut.

10. The fastening arrangement according to claim 1, wherein the first base body and the second base body each have an outer sleeve and an inner sleeve, the inner sleeve arranged coaxially inside of and fixed to the outer sleeve.

11. The fastening arrangement according to claim 10, wherein the outer sleeve is composed of:
a rubber material;
an elastomer;
a silicone;
a mixture of different rubber materials; and/or
a mixture of different rubber materials and a metal, a metal braiding, and/or a metal alloy.

12. The fastening arrangement according to claim 10, wherein the inner sleeve includes:
a single outer flange; or
two opposing outer flanges.

13. The fastening arrangement according to claim 10, wherein, in an assembled state of the fastening arrangement, the outer sleeve of the first base body and/or the outer sleeve of the second base body is elastically compressed along the opening center axis and is elastically widened radially with respect to the opening center axis.

14. A bicycle, comprising:
at least one fastening arrangement according to claim 1;
a drive unit for driving the bicycle, the drive unit including a housing having two opposing housing openings that are coaxially arranged along an opening center axis, the two housing openings including a first housing opening and a second housing opening; and
a bicycle frame configured to carry the drive unit and a rider, the bicycle frame including two frame openings aligned with the two housing openings of the drive unit;
the first base body of the first screw holder arranged in the first housing opening and fixed in a rotationally and axially fixed manner on an inner circumference of the first housing opening;
the second base body of the second screw holder arranged in the second housing opening and fixed in a rotationally and axially fixed manner on an inner circumference of the second housing opening;
the step screw arranged such that i) the shaft extends through the two frame openings, the two housing openings, the first longitudinal bore of the first screw holder, and the second longitudinal bore of the second screw holder and ii) the head is in contact with the bicycle frame;
wherein the first base body is supported on the first unthreaded round section;
wherein the second base body is supported on the second unthreaded round section;
wherein the nut is screwed onto the threaded section of the step screw such that i) the nut is supported on the bicycle frame and ii) the first base body is clamped between the shaft step of the step screw and the bicycle frame; and
wherein the first base body and/or the second base body is elastically compressed along the opening center axis and elastically widened radially with respect to the opening center axis.

15. A pre-assembled unit, comprising:
at least one fastening arrangement according to claim 1; and
a drive unit for a bicycle, the drive unit including at least one housing opening for fastening and/or securing the drive unit via at least one fastener;
wherein the first screw holder and/or the second screw holder of the at least one fastening arrangement is removably arranged in the at least one housing opening of the drive unit.

16. The fastening arrangement according to claim 1, wherein the shaft is a hollow shaft.

17. The fastening arrangement according to claim 1, wherein the nut includes a through-hole.

18. The fastening arrangement according to claim 1, wherein the nut is an eccentric nut.

19. A fastening arrangement for fastening a drive unit to a bicycle frame, comprising:
a step screw including a shaft and a head, the shaft including:
a threaded section;
a first unthreaded round section arranged directly adjacent to the threaded section;
a second unthreaded round section arranged directly adjacent to the first unthreaded round section; and
a circumferential shaft step defined by and between the first unthreaded round section and the second unthreaded round section;
the head arranged on an end of the second unthreaded round section opposite the first unthreaded round section;
a nut screwable onto the threaded section of the step screw;
a first screw holder including a first hollow cylindrical base body and a first longitudinal bore extending through the first base body; and
a second screw holder including a second hollow cylindrical base body and a second longitudinal bore extending through the second base body;
wherein the first base body and the second base body are insertable into two opposing housing openings of a housing of the drive unit such that i) the first base body is fixable in a rotationally and axially secure manner on an inner circumference of a first housing opening of the two housing openings and ii) the second base body is fixable in a rotationally and axially secure manner on an inner circumference of a second housing opening of the two housing openings; and
wherein, when the step screw is inserted through i) two opposing frame openings of the bicycle frame, ii) the two housing openings, iii) the first longitudinal bore of the first screw holder, and iv) the second longitudinal bore of the second screw holder and the nut is screwed onto the threaded section of the step screw,
the first base body is supported on the first unthreaded round section of the step screw;
the second base body is supported on the second unthreaded round section of the step screw;
the nut is supported on the bicycle frame; and
the first base body is clamped between the shaft step of the step screw and the bicycle frame.

20. The fastening arrangement according to claim 19, wherein:
the threaded section has a thread diameter;
the first unthreaded round section has a first diameter that is greater than or equal to the thread diameter; and
the second unthreaded round section has a second diameter that is greater than the first diameter.
